(19) United States
(12) Patent Application Publication
(10) Pub. No.: US 2005/0071205 A1
(43) Pub. Date: Mar. 31, 2005

(54) Mortality linked bond obligation

(75) Inventors: James D. Terlizzi, Delray Beach, FL (US); Timothy J. Trankina, Alpharetta, GA (US)

Correspondence Address: FOLEY AND LARDNER;SUITE 500, 3000 K STREET NW, WASHINGTON, DC, 20007, US

(73) Assignee: SETTLEMENT FUNDING INC.

(21) Appl. No.: 10/860,639

(22) Filed: Jun. 4, 2004

Related U.S. Application Data
(60) Provisional application No. 60/475,510, filed on Jun. 4, 2003.

(51) Int. Cl. G06F 17/60

(52) U.S. Cl. 705/4; 705/35

(57) ABSTRACT

A method for investing, including causing the formation of a first agreement for the transfer of benefits of an insured's life insurance policy to a first entity and the transfer of premium payment obligations of the insured's life insurance policy to the first entity or a second entity in exchange for a payment to at least one of an owner of the life insurance policy and a third entity; causing the formation of a second agreement for the transfer of money to a fourth entity in return for annuity payments comprising periodic payments substantially for the life of the insured; causing the formation of a third agreement for the transfer of money from a fifth entity in return for repayment at a later date, the repayment at a later date comprising principal substantially equal to the full amount of the money transferred from the fifth entity plus interest, wherein payment of the principal is backed by benefits of the insured's life insurance policy and wherein the interest is backed by the annuity payments of the second agreement.

### CROSS REFERENCE TO RELATED APPLICATIONS

This application claims priority to U.S. Provisional Patent Application No. 60/475,510, filed on Jun. 4, 2003, entitled MORTALITY LINKED BOND OBLIGATION, the contents of which are incorporated herein by reference in their entirety. This application also claims the subject matter of co-pending U.S. patent application Ser. No. 10/616,458, entitled METHOD AND SYSTEM FOR INVERSE LIFE ANNUITY, the contents of which are incorporated herein by reference in their entirety.

### BACKGROUND OF THE INVENTION

Life insurance policies are a well established way for people, corporations, etc., to protect against the early demise of an important person. The concept behind a life insurance policy is that people who are important or who have responsibilities, financially or otherwise, to other individuals or groups of people or organizations, while planning to live for a sufficient period of time to fulfill those duties, may in fact die prior to that period of time. By way of example, parents plan on living at least until their children reach an age where they can lead their own lives and be self-supporting. Thus, parents with newborn children often purchase life insurance policies with their children identified as beneficiaries (i.e., the children receive money from the life insurance policy receive money from the life insurance policy at or after the death of the insured parents), the money received from the policy being used to raise, educate and otherwise provide for the children because the parents are not available to do so because they are dead. However, in many cases, the life insurance policy death benefits are not needed because the insured person outlives the critical period for which the insurance money was believed to be necessary. Again referring to the parental example, where the benefits of the life insurance policy were planned to be used to raise the children in the event of the parents premature death, the insurance policy would no longer be needed when, for example, their children have reached their 30s and are on their own. However, in the just described scenario, when the main reason for the insurance policy cease to exist, the insurance policy is usually still in effect and the premiums are still due to the carrier of the insurance policy (e.g., the life insurance company).

In this situation, the owners of the life insurance policy (e.g. the parents in the just mentioned scenario) are usually faced with the following alternatives. First, they can simply stop paying the premium payments and allow the policy to lapse. This would have the effect of freeing the parents from having to make future premium payments. However, any equity that they had in the life insurance policy would be lost and they would have no further benefits under the policy.

A second alternative could be to surrender the policy for its “cash-out” value. That is, many insurance policies have a contingency where the owners of the policy can go to the insurance company and basically surrender the policy (that is, free the insurance company from the requirement to pay a benefit upon the insured's death) in return for a cash payment. This does have the advantage of providing the owner of the policy with some form of cash benefit. However, in such a situation, the cash benefit could be quite small in comparison to the payout of the policy in the event of the death of the insured. By way of example and not by way of limitation, a life insurance policy that has as a death benefit a payment of $1 million to the beneficiaries may have a cash-out value of only $100,000.00, even though the owner of the policy has paid the premiums for this life insurance policy, for example, for 25 to 30 years, and there is a better than even chance that the insured person will become deceased within the next 10 to 15 years. Thus, exercising the cash-out option creates a windfall to the insurance company because they will have to only pay out $100,000.00 today, as opposed to having to pay out $1 million, 10, 15 or even 20 years in the future. Even taking into account the stock market boom of the late 90s and ignoring the stock market performance since 1999, such an investment would be considered quite profitable by most measures. Still further, when the amount of money that was paid to the insurance company in the form of premium payments by the owner of the policy is taken into account, the owner of the policy incurs a substantial loss on his or her investment (as compared to the benefits that would be paid as a result of the insured's death). Still, the cash-out value of the policy does leave the owner of the policy with something more than what they would have if they simply allow the policy to lapse, at least in the case where the owner of the policy is the insured.

A third alternative could be to continue to making premium payments to the policy and maintain the policy in-force. However, this does not provide the owner of the policy with immediate funds or money in the short run (or potentially ever, in the case where the owner of the policy is the insured person because the policy may not pay a benefit out until the insured person is dead). Further, this does not relieve the owner of the policy from the burden of making premium payments.

In view of the above, it is quite clear that there are, at least in some instances, insurance policies that would be quite valuable to an investor who, such as, for example, a provider of a life settlement, has the ability to wait for a fixed period of time and/or an uncertain period of time based on, for example, the life expectancy of the insured person, to receive the benefits of the insurance policy if the investor is willing to assume or find someone to assume the premium payments of the life insurance policy and if the investor is willing to pay the owner of the policy something different than he would otherwise receive by following one or more of the just described options.

However, there are a number of problems faced by the provider of the life settlement. For example, the provider of the life settlement must pay the owner of the life insurance policy the lump sum settlement up-front and then wait years or possibly even decades before receiving a pay-out from the life insurance policy. Still further, the provider of the life settlement must also assume the premium payment obligations or otherwise account for and have paid the premium payment obligations on the life insurance policy. This could extend again for decades depending on how long the insured person lives and/or the terms of the policy. While typically minor in comparison to the just discussed costs, there are also administrative costs which can amount to thousands or even tens of thousand dollars per year. Again, theses are all payments that must be made either immediately or during the life of the insured person prior to receiving, in many cases a single payment from the insurance policy. Finally, and perhaps even most important, the provider of the life settlement must demonstrate or otherwise prove that they can make all the premium payments to keep the policy in force in the event that they are trying to obtain some sort of financing. Another problem with the life settlement system is that in many cases, there is no certainty in the outcome. That is, it is never certain as to when the insured person will die, thus the supplier of the life settlement is faced with a situation were he or she has absolutely no control over his or her future in regard to the payment of premiums.

### SUMMARY OF THE INVENTION

There is a first computer implemented method for investing, comprising causing the formation of a first agreement for the transfer of benefits of an insured's life insurance policy to a first entity and the transfer of premium payment obligations of the insured's life insurance policy to the first entity or a second entity in exchange for a payment to at least one of an owner of the life insurance policy and a third entity, causing the formation of a second agreement for the transfer of money to a fourth entity in return for annuity payments comprising periodic payments substantially for the life of the insure, and causing the formation of a third agreement for the transfer of money from a fifth entity in return for repayment at a later date, the repayment at a later date comprising principal substantially equal to the full amount of the money transferred from the fifth entity plus interest, wherein payment of the principal is backed by benefits of the insured's life insurance policy and wherein the interest is backed by the annuity payments of the second agreement.

There is a method according to the above or below methods, wherein the wherein the third agreement is contingent on the formation of the first agreement and the second agreement.

There is a method according to one or more of the above and/or below methods, wherein the payment to at least one of an owner of the life insurance policy and a third entity occurs in close temporal proximity with the consummation of the first agreement.

There is a method according to one or more of the above and/or below methods, wherein an entity other than the fifth entity receives the payment of the interest.

There is a method according to one or more of the above and/or below methods, wherein the annuity of the second agreement is paid to at least one of the first entity and the second entity, wherein the transfer of money from the fifth entity is transferred to at least one of the first entity and the second entity, wherein the repayment at a later date of the third agreement comprises the receipt of periodic payments by the fifth entity of an amount substantially equal to the agreed upon interest of an interest payment schedule, wherein the repayment at a later date of the third agreement further comprises the receipt shortly after the death of the insured of an amount substantially equal to the full amount of the money transferred from the fifth entity, wherein the payment to at least one of an owner of the life insurance policy and a third entity is made by at least one of the first and second entities, wherein the transfer of money to the fourth entity is paid by at least one of the first and second entities, wherein the repayment of the third agreement is paid by at least one of the first and second entities, and wherein the premium payments are backed by the annuity payments of the second agreement.

There is a method according to one or more of the above and/or below methods, wherein the interest payments stop at the death of the insured.

There is a method according to one or more of the above and/or below methods, wherein the first entity is the same as the fifth entity.

There is a method according to one or more of the above and/or below methods, wherein the premium payments are backed by the annuity payments of the second agreement.

There is a method according to one or more of the above and/or below methods, wherein there is only one payment to at least one of an owner of the life insurance policy and a third entity.

There is a method according to one or more of the above and/or below methods, wherein the only one payment is paid to both the owner of the policy and a third entity.

There is a method according to one or more of the above and/or below methods, wherein the repayment of the third agreement comprises the receipt of periodic payments by the fifth entity of an amount substantially equal to the agreed upon interest of an interest payment schedule.

There is a method according to one or more of the above and/or below methods, wherein the repayment of the third agreement comprises the receipt shortly after the death of the insured of an amount substantially equal to the full amount of the money transferred from the fifth entity.

There is a method according to one or more of the above and/or below methods, wherein the repayment of the third agreement occurs at either a time shortly after the death of the insured or a time specified in the third agreement in the event that the insured is not dead prior to the specified time, the repayment comprising the receipt of an amount substantially equal to the full amount of the money transferred from the fifth entity.

There is a method according to one or more of the above and/or below methods, wherein the repayment of the third agreement occurs at either a time shortly after the death of the insured or a time specified in the third agreement in the event that the insured is not dead prior to the specified time, the repayment comprising the receipt of an amount substantially equal to the combined amount of interest owed to the fifth entity.

There is a method according to one or more of the above and/or below methods, wherein the interest payment is made in close temporal proximity to the consummation of the first agreement.

There is a method according to one or more of the above and/or below methods, wherein no interest is paid until either a time shortly after the death of the insured or a time specified in the third agreement in the event that the insured is not dead prior to the specified time.

There is a method according to one or more of the above and/or below methods, wherein the annuity of the second agreement is paid to at least one of the first entity and the second entity.

There is a method according to one or more of the above and/or below methods, wherein the first entity and the second entity are the same.

There is a method according to one or more of the above and/or below methods, wherein the transfer of money to the fourth entity is transferred from the fifth entity.

There is a method according to one or more of the above and/or below methods, wherein the transfer of money to the fourth entity is associated with money transferred from the fifth entity.

There is a method according to one or more of the above and/or below methods, wherein the repayment of the principal is paid to the fifth entity by at least one of the issuer and the successor to the issuer of the life insurance policy.

There is a method according to one or more of the above and/or below methods, wherein the repayment of the principal is paid to the fifth entity by the issuer of the life insurance policy.

There is a method according to one or more of the above and/or below methods, wherein the repayment of the principal paid to the fifth entity is associated with the benefits of the insured's life insurance policy.

There is a method according to one or more of the above and/or below methods, wherein the periodic payments paid to the fifth entity by the fourth entity and comprise at least a portion of the annuity payments.

There is a method according to one or more of the above and/or below methods, wherein the periodic payments paid to the fifth entity are associated with the annuity payments from the fourth entity.

There is a method according to one or more of the above and/or below methods, wherein the premium payment obligations of the life insurance policy are paid by the fourth entity and comprise at least a portion of the annuity payments.

There is a method according to one or more of the above and/or below methods, wherein the premium payment obligations of the life insurance policy are associated with the annuity payments.

There is a method according to one or more of the above and/or below methods, wherein the amount of money transferred from the fifth entity in return for repayment at a later date is about equal to the amount of a death benefit from the life insurance policy.

There is a method according to one or more of the above and/or below methods, wherein the amount of money transferred to the fourth entity is equal to an amount that will cause the fourth entity to agree to have annuity payments paid for the life of the insured in an amounts that are about equal to the sum of the premium payment obligations of the life insurance policy and the interest of the third agreement.

There is a method according to one or more of the above and/or below methods, wherein the fourth entity pays the annuity.

There is a method according to one or more of the above and/or below methods, wherein the amount of money transferred to the fourth entity is about equal to an amount that will cause the fourth entity to agree to have annuity payments paid for the life of the insured in an amounts that are about equal to the sum of the premium payment obligations of the life insurance policy, the interest of the third agreement, and administrative fees and costs associated with the formation of the agreements and the enforcement of the agreements.

There is a method according to one or more of the above and/or below methods, wherein the amount of money transferred to the fourth entity is about equal to the amount transferred from the fifth entity minus the amount paid to at least one of the owner of the life insurance policy and the third entity.

There is a method according to one or more of the above and/or below methods, wherein the amount of money transferred to the fourth entity is about equal to the amount transferred from the fifth entity minus (A) the amount paid to at least one of the owner of the life insurance policy and the third entity and (B) administrative expenses.

There is a method according to one or more of the above and/or below methods, wherein the amount of money transferred to the fourth entity is about equal to an amount that will cause the fourth entity to agree to have annuity payments paid for the life of the insured in an amounts that are greater than the sum of the premium payment obligations of the life insurance policy, the interest of the third agreement, and administrative fees and costs associated with the formation of the agreements and the enforcement of the agreements.

There is a method according to one or more of the above and/or below methods, wherein the amount of money transferred to the fourth entity is about equal to an amount that will cause the fourth entity to agree to have annuity payments paid for the life of the insured in an amounts that are greater than the sum of the premium payment obligations of the life insurance policy, the interest of the third agreement, and administrative fees and costs associated with the formation of the agreements and the enforcement of the agreements, and wherein the amount of money transferred to the fourth entity is about equal to the amount transferred from the fifth entity minus the amount paid to at least one of the owner of the life insurance policy and the third entity.

There is a method according to one or more of the above and/or below methods, wherein the amount of money transferred to the fourth entity is about equal to an amount that will cause the fourth entity to agree to have annuity payments paid for the life of the insured in an amounts that are greater than the sum of the premium payment obligations of the life insurance policy, the interest of the third agreement, and administrative fees and costs associated with the formation of the agreements and the enforcement of the agreements, and wherein the amount of money transferred to the fourth entity is less than the amount transferred from the fifth entity minus the amount paid to at least one of the owner of the life insurance policy and the third entity.

There is a method according to one or more of the above and/or below methods, wherein the annuity payments paid that are substantially in excess of the sum of the premium payment obligations of the life insurance policy, the interest of the third agreement, and administrative fees and costs associated with the formation of the agreements and the enforcement of the agreements.

There is a method according to one or more of the above and/or below methods, wherein the life insurance policy was issued at least two years prior to the formation of the first agreement.

There is a method according to one or more of the above and/or below methods, wherein the life insurance policy is incontestable.

There is a method according to one or more of the above and/or below methods, wherein the life insurance policy is incontestable as based on the NAIC regulations.

There is a method according to one or more of the above and/or below methods, further comprising evaluating the flexibility of the premium payment obligations of the life insurance policy, wherein the first agreement is contingent on the evaluation.

There is a method according to one or more of the above and/or below methods, wherein evaluating the flexibility of the premium payment obligations of the life insurance policy entails evaluating the insurance carrier's illustration of the fixed policy premium amount for the life of the insured.

There is a method according to one or more of the above and/or below methods, wherein the illustration is in substantial compliance with NAIC regulations.

There is a method according to one or more of the above and/or below methods, further comprising evaluating the annual certifications from the insurance carrier's illustration actuary.

There is a method according to one or more of the above and/or below methods, further comprising evaluating the annual certifications from an illustration actuary.

There is a method according to one or more of the above and/or below methods, further comprising forming a plurality of first, second and third agreements, evaluating the flexibility of the premium payment obligations of the life insurance policies of the agreements, wherein the first agreements are contingent on the evaluations, and wherein the average premium for the plurality of agreements is substantially constant for about seven years after the formation of the first agreements.

There is a method according to one or more of the above and/or below methods, wherein the life insurance policy is controlled by the bankruptcy laws that permit the beneficiaries of the policy to take ahead of most other creditors.

There is a method according to one or more of the above and/or below methods, wherein the life insurance policy is controlled by the bankruptcy laws that permit the beneficiaries of the policy to take ahead of substantially all other creditors.

There is a method according to one or more of the above and/or below methods, further comprising forming a fourth agreement for the transfer of the premium payment obligations and the payment of an amount equal to the full amount of money transferred from the fifth entity after an agreed upon time in the event that the insured has not died from either the first entity or the second entity in return for a payment to a sixth entity.

There is a method according to one or more of the above and/or below methods, further comprising forming a fourth agreement for the transfer of the premium payment obligations and the payment of an amount equal to the full amount of money transferred from the fifth entity after an agreed upon time in the event that the insured has not died from either the first entity or the second entity in return for a payment in close temporal proximity with the consummation of the fourth agreement to a sixth entity.

There is a method according to one or more of the above and/or below methods, wherein the sixth entity is a life contingency insurer or a performance bond issuer or other guarantor.

There is a method according to one or more of the above and/or below methods, wherein the transfer of the premium payment obligations from either the first entity or the second entity can be blocked by the first entity or the second entity after the formation of the fourth agreement.

There is a method according to one or more of the above and/or below methods, wherein the agreed upon time in the event that the insured has not died is about two years after the expected approximate death date of the insured.

There is a method according to one or more of the above and/or below methods, further comprising using a personal computer to practice the method.

There is a method according to one or more of the above and/or below methods, wherein the payment to at least one of the owner of the life insurance policy and the third entity comprises periodic payments and/or periodic payments coupled with a lump sum payment.

There is a method according to one or more of the above and/or below methods, wherein the periodic payments paid to at least one of the owner of the life insurance policy and the third entity is backed by the annuity payments.

There is a method according to one or more of the above and/or below methods, wherein the periodic payments paid to at least one of the owner of the life insurance policy and the third entity is paid by the fourth entity.

### BRIEF DESCRIPTION OF THE DRAWINGS

FIG. 1 is a flow chart of an embodiment of the present invention.

FIG. 2 is a block diagram showing a possible relationship between the entities and the agreements according to the present invention.

FIG. 3 is a block diagram showing a possible relationship between the entities and the agreements according to the present invention.

FIG. 4 is a schematic of a computer system according to the present invention.

### DETAILED DESCRIPTION OF THE PREFERRED EMBODIMENTS

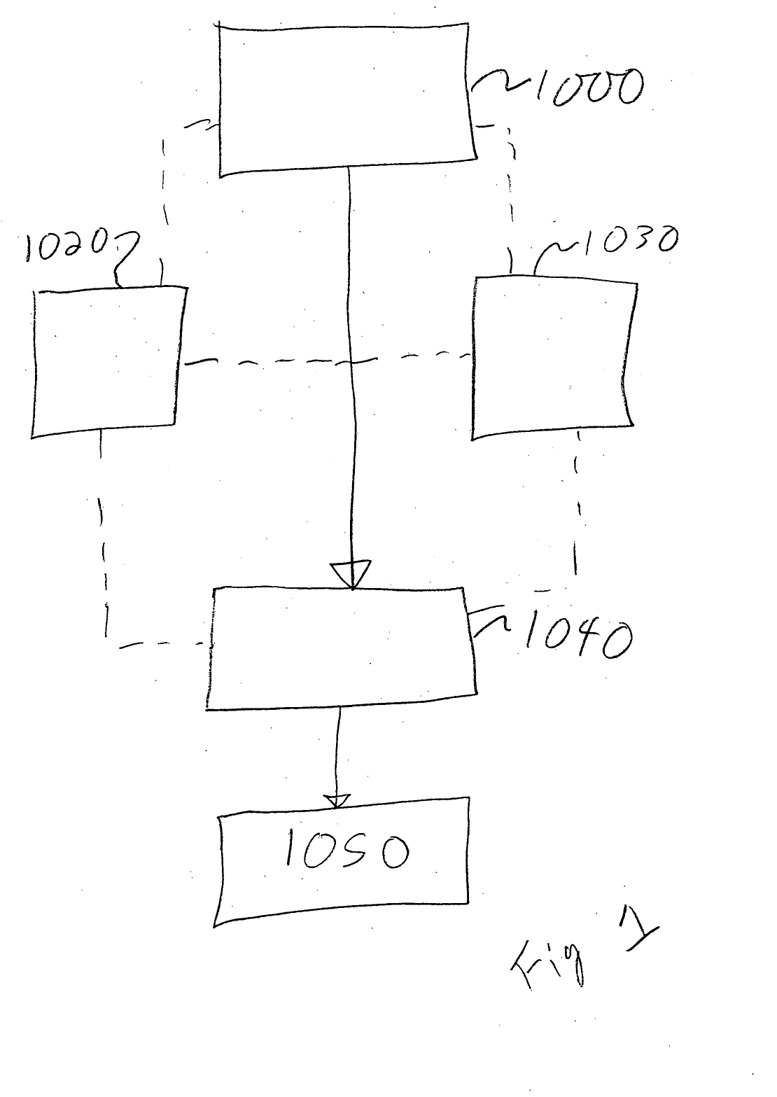

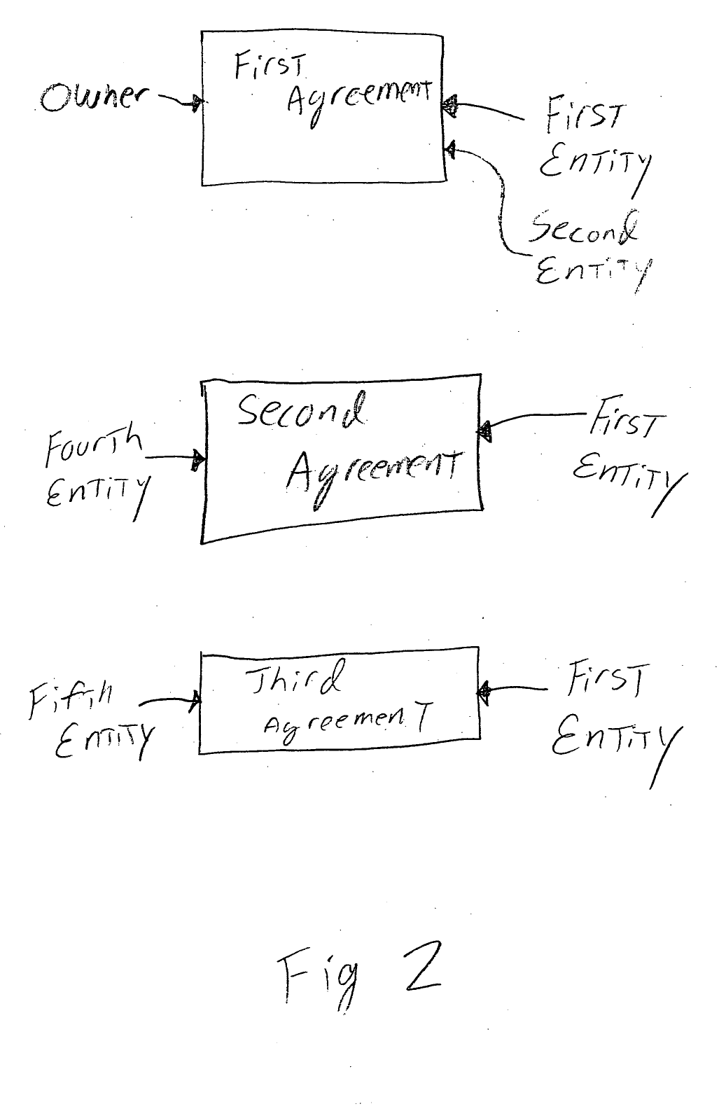

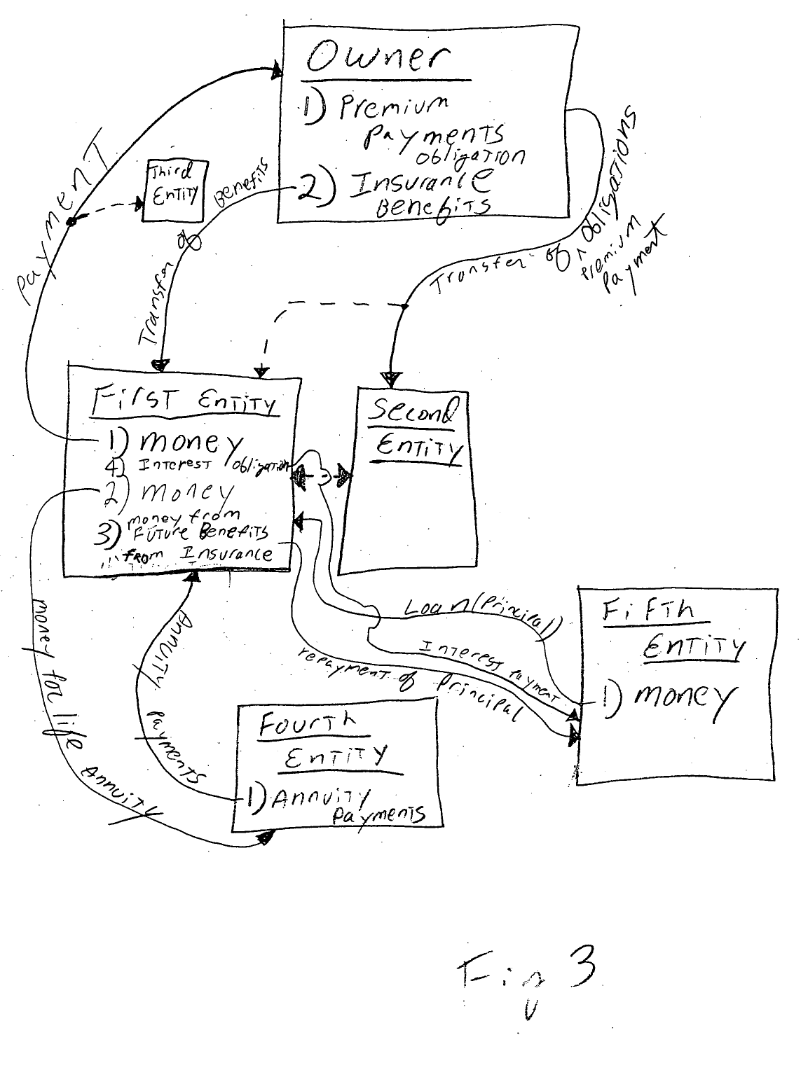

Referring to FIGS. 1-3, there is a method of investing according to the present invention where an insured person, who has previously purchased a life insurance policy at 1000, thus making him or her an owner of the policy, approaches or is approached by a first entity at 1010 at which point an offer is made to exchange the rights to the benefits of the life insurance policy in return for a payment to the owner. After working out the details of the agreement, an agreement is formed at 1040 for the transfer of the present and/or future benefits of the life insurance policy (e.g. death benefits) and for the transfer of premium payment obligations in return for a owner. The second agreement, formed at 1020, calls for the transfer of money to a life annuity company in return for annuity payments comprising, for example, monthly payments that will be paid to the first entity for the life of the insured. The third agreement is formed at 1030, and can be contingent on the formation of one or more of the other agreements, and calls for the payment of money from a bank or other financial institution to the first entity, in return for the repayment of the principal upon the death of the insured (where the principal coincides with the amount that will be paid as a death benefit according to the policy) and monthly interest payments. The monthly payments of the annuity are equal to the sum of the monthly interest payments to the bank, the monthly premium payments (or divided to approximate a monthly payment) to be paid to the life insurance company, and administrative expenses associated with practicing the invention. Thus, after paying the first entity and the life annuity company, and other various expenses, the first entity is left with money left over from the payment from the bank at 1030. At 1050, the insured person dies, at which point the first entity receives the death benefit from the insurance company and uses it to repay the bank the principal of the loan, thus, providing that the interest payments have also been made, canceling the debt. Also at 1050, the annuity company stops paying annuities to the first entity.

Thus, according to one aspect of the present invention, there is a method of securing financing for a life settlement agreement that is backed by very firm and secure property.

Embodiments of the present invention will now be discussed in further detail.

According to a first embodiment of the present invention, there is a method for investing comprising the formation of an agreement whereby the owner of a life insurance policy surrenders all or part of the benefits of that policy to another company, another party, etc. (hereinafter referred to as “the first entity”) in return for a payment to be paid to the owner of the policy and/or another party or parties at or about the time of the formation of the agreement. According to this embodiment of the invention, there is, by way of example, a life insurance policy that is viewed as being no longer needed by its owner and/or considered less valuable than it once was by its owner. For example, due to changing circumstances, the owner of the life insurance policy finds that he or she is now in need of a substantial amount of money, and that receiving this money would be more attractive than keeping the policy in force or exercising other available alternatives. In the first embodiment of the present invention, the life insurance policy is owned by the insured, the person on which the life insurance policy depends (i.e., the person upon who's death the life insurance policy will pay a benefit). However, in other embodiments of the present invention, the insured person is not the owner of the policy. By way of example and not by way of limitation, the insured person could be a key man in a company, and the company could own the policy. In such an embodiment, the company could be the beneficiary of the policy. That is, the company would receive the payout from the life insurance company that issued or is currently obligated to pay the benefits under the life insurance policy. In other embodiments, the company could have taken out the insurance policy and identified the insured's family as the beneficiaries of the policy.

The present method of investing can be practiced by forming an agreement between the owner of the life insurance policy and the first entity. By way of example only and not by way of limitation, this first entity could be a company that specializes in practicing the present invention, such as an insurance company, a life settlement company, or other form of investment company. Further, by way of example, this first entity could be a company that specializes in settlement funding. Regardless of the form of the company, the first entity makes an agreement whereby the first entity will assume the obligations of paying the premium payments to keep the life insurance policy that is owned by the owner in effect, in return for the owner of the life insurance policy assigning or otherwise transfer the benefits, in whole or in part, of the life insurance policy to the first entity. It is noted that the present invention can be practiced in embodiments where the first entity is designated to receive the benefits of the life insurance policy, while a second entity is designated as being responsible for making the premium payments to keep the policy in force. This could be done, by way of example only and not by way of limitation, in a scenario where the two entities are companies that are closely held or at least substantially held by the same company or person, or where the first entity owns a portion of the second entity, and, for tax reasons or liability reasons, etc., it would be profitable to have one entity obtain the benefits under the policy while having the other entity take on the liability of keeping the policy in force. Still, it is noted that other embodiments of the present invention could be practiced wherein the entity assuming the benefits of the insurance policy is the same as the entity that agrees to assume the burden (that is to pay the premium payment obligations) under the agreement.

It is noted that the term “owner” is used throughout this application, and refers to the person and/or entity that owned the life insurance policy at the time of the agreement, and does not necessarily refer to the owner of the policy after the agreement is consummated. That is, the present invention contemplates both the outright sale of the insurance policy to the first and/or second entity at or around the time of the agreement, and the simple assignment of some or all of the rights under the insurance policy at or around the time of the agreement. Thus, in the former, the “owner” no longer owns the life insurance policy after the agreement, but can still be referred to as the owner for the purposes of this application, while in the latter, the owner still may own the life insurance policy.

The method according to the present invention is practiced by having the owner of the life insurance policy transfer at least a portion of his rights under the life insurance policy (or the rights of a beneficiary) away in return for a payment. In one embodiment of the present invention, this payment could be paid to the owner of the life insurance policy. However, other embodiments of the present invention could be practiced whereby this payment could be paid to someone other than the owner of the life insurance policy (hereinafter referred to as a third entity) such as for example the owner's only child. Still further, other embodiments of the present invention could be practiced wherein a payment is paid to the owner and a payment is made to a third entity. It is also noted that additional entities could receive these payments as well (e.g., each of the owner's 5 children, etc.).

According to other embodiments of the present invention, in the first agreement, the owner of a life insurance policy surrenders all or part of the benefits of that policy to the first entity in return for periodic payments to be paid to the owner of the policy and/or another party or parties, for a period of time.

In using the phrase periodic payments, it is meant that a payment is made periodically over a period of time. By way of example only and not by way of limitation, a weekly payment, a monthly payment, a yearly payment, a quarterly payment, and a biannual payment would all be considered periodic payments. Also, payments that skipped some payment periods would also be included in the phrase periodic payments.

Still further, when practicing an embodiment of the present invention where the owner of the life insurance policy and a third entity receives a periodic payment, the phrase includes payments that are sent to both the owner and the third entity periodically (i.e., both the owner and the third entity receive payments at or around the same time). For example, on May 1, a check would be mailed to both the owner and a third entity. In this invention, the periodic payments also include payments that are sent to an owner and a third entity but where periodic payments are first made to the owner and then periodic payments are made to the third entity. By way of example and not by way of limitation, periodic payments could be first made over the course of the first year to the owner (or over a portion of the first year to the owner), and then, in the second year, periodic payments could shift to the third entity. Still further by way of example, periodic payments could then shift back to the owner in the third year and could continue, for example, into the fifth year, after which the periodic payments could then shift back to the third entity. Still further by way of example, the present invention can be practiced whereby the owner first begins to receive periodic payments, and then the owner and the third entity receive periodic payments at the same time, and then the owner stops receiving the periodic payments but the third entity continues to receive the periodic payments and/or vice-versa. As yet another example, the third entity could begin to receive the periodic payments before the owner. Thus, any form of periodic payment that is made to the third entity and/or the owner constitute a periodic payments for a period of time to at least one of an owner of the life insurance policy and a third entity.

As can be seen, the periodic payments could be made payable to the owner and/or the third entity or others for a period of time. This period of time could be based on a number of factors. By way of example only and not by way of limitation, the period of time could be a fixed period determined at or in close temporal proximity to the formation of the first agreement according to the present invention to transfer the benefits and obligations of the life insurance policy. In other embodiments of the present invention, this period of time could be based on the life of the insured. By way of example, the first agreement could stipulate that the periodic payments would be made to the owner up until the time that the insured person died. Such a practice might be analogous to paying life insurance premiums up until the insured person dies, as usually, premium payments are not made after the insured person dies. (It is noted that some life insurance policies do have a clause wherein the requirement to pay premium payments to maintain the life insurance policy stops after the insured reaches a certain age. Thus, the just mentioned example might not be exactly analogous with every form of life insurance policy.)

Still further, the period of time could be based on a variable time as well. By way of example and not by way of limitation, the present invention could be practiced where a variable period of time results from an agreement, where the periodic payments would be made for the life of the insured, but in the case of a significant event beyond the control of the first and/or second entity, the period of time of the periodic payments would be substantially shortened and/or the payments would be immediately stopped or stopped at a date certain upon such event. For example, if interest rates radically increase or decrease (by an amount, for example, that can be predetermined and identified in the first agreement), the periodic payments could be suspended. Still further by example, in the just mentioned scenario, if interest rates return to a stable level, the periodic payments could again take effect.

Thus, the present invention could be practiced using a variety of time periods that constitute periods of time. These periods of times are not limited to the just mentioned examples, as the present invention can be practiced with time periods based on virtually any appropriate time scale that is agreeable to the parties to the first agreement and/or any other necessary party or entity.

As noted above, the present invention can be practiced wherein the periodic payments are made for a period of time to at least one of an owner of the life insurance policy and a third entity. The present invention can also be practiced, by way of example, in combination with a payment of at least one lump-sum payment to either the owner of the life insurance policy or a third entity, or a lump-sum payment to both the owner of the policy and a third entity, or a lump-sum payment made to an entity other than the owner and the third entity, wherein the third entity is receiving periodic payments. Still further by example, the lump-sum payment could be made only to a third entity and not the owner, where the owner of the life insurance policy receives periodic payments and the third entity only receives the lump-sum payment. Still further by example, the present invention could be practiced whereby the owner only receives a lump-sum payment and a third entity or entities receive periodic payments. In yet another example, the present invention could be practiced wherein an entity other than the owner and the third entity only receives a lump-sum payment. Thus, any combination of payments or types of payments can be utilized to practice the present invention.

In yet further embodiments of the present invention, this lump-sum payment coupled with the periodic payments is made in very close temporal proximity with the consummation of the first agreement for the transfer of benefits according to the present invention. By way of example only and not by way of limitation, when the owner of the insurance policy or the owner's agents meets with the entity or entities that are assuming the liability and/or identified to receive the benefits of the life insurance policy to sign the first agreement, a check representing a lump-sum payment could be given to the owner when the first agreement is signed. Alternatively or in addition to this, a check representing a lump-sum payment could be given to the owner within a few days of the consummation of the agreement.

As part of the formation of the agreement according to the present invention, all or part of the obligations to pay premium payments for the life insurance policy are transferred from the owner or other responsible paying party to another entity (e.g., the first and/or second entity). In the first embodiment of the present invention, these premium payment obligations include the periodic premium payments that are required to maintain the life insurance policy. In one embodiment of the present invention, these periodic premium payments include payments which could be based on, by way of example, either a monthly, a quarterly, and an annually payment schedule, and could also be based on a weekly or semi-annual, or biannual payment schedule as well. Indeed, any periodic or non-periodic premium payment that is required by the issuer of a life insurance policy to maintain the life insurance policy in force would be covered by the phrase periodic premium payments.

Other embodiments of the present invention include the formation of a second agreement which could be separate from the first agreement. This second agreement could entail the assignment of some or all of any rights to the periodic payments and/or lump sum payments that the owner or other entity might be entitled to resulting from the first agreement to another entity. By way of example and not by limitation, the owner could form a first agreement wherein the first agreement includes a provision that the owner receives $10,000 per month from the first entity. In a second agreement, the owner could then agree to assign $1,000 per month of the $10,000 to another entity. This could be, for example, an assignment to the owner's child or to the owner's grandchild, etc. This might be desirable for tax purposes or for either estate and/or income tax purposes, etc. In other embodiments, this second agreement could result in the assignment of say, the first five payments in a given year to the assignee, after which the owner could then receive the remaining seven payments, in the case where the periodic payments are paid per month. Still further, in other embodiments, the entire $10,000 per month could be assigned to another entity.

The periodic payments according to some embodiments of the present invention are equal to each other or substantially equal to each other. That is, for example, the payment received in January, for a monthly periodic payment schedule, would be the same as that received in March of the same year, and would also be the same as that received in the same months ten years hence. (In the event that the insured is still alive and/or the fixed period of time has not elapsed or some other event has not occurred that would serve to stop the payments.) However, other embodiments of the present invention can be implemented, wherein the periodic payments decrease over time or, alternatively, where the periodic payments increase over time. Still further by example, embodiments of the present invention could be practiced wherein the periodic payments decrease over time and then increase over time and then decrease over time and then stay the same for a period of time, after which they could either again increase or decrease or stay the same. That is, the present invention could be practiced with a wide variety of payment schedules.

In the case where payments decrease or increase over time, some embodiments of the present invention could be practiced whereby the periodic payments decrease uniformly or substantially uniformly over time. That is, for example, every month, the payments could be reduced by $10.00. Or alternatively, all of the monthly payments in a given year could be equal to $10,000.00, and then, in the following year each monthly payment could be $9,500.00, and then, in the next year each payment could be $9,000.00. This would work in reverse in the case of increasing payments.

According to the present invention, there is the formation of a second agreement for the transfer of money to yet a fourth entity in return for annuity payments for the life of the insured. In the first embodiment of the present invention, these annuity payments comprise periodic payments that are made throughout the life of the insured. By way of example only and not by way of limitation, one of the first and/or second entities agrees to transfer money to a fourth entity, for example, five hundred thousands dollars, and in return, the fourth entity pays the first and/or second entity a monthly payment of, for example, seven thousand dollars per month. In yet other embodiments of the present invention, the annuity payments comprising periodic payments that comprise paying a payment to the first and/or second entity every year. For example, in return for a transfer of five hundred thousand dollars to the fourth entity, the fourth entity could agree to pay eighty-four thousand dollars per year, payable at one year intervals on, for example, the anniversary date of the formation of the first or second agreement or another date that is mutually agreeable to the entities. Any type of periodic payment can be used to practice various embodiments of the present invention.

In using the phrase periodic payments, it can be meant that a payment is made periodically over a period of time, based on, for example, a payment schedule. By way of example only and not by way of limitation, a weekly payment, a monthly payment, a yearly payment, a quarterly payment, and a biannual payment would all be considered periodic payments. Also, payments that skipped some payment periods would also be included in the phrase periodic payments.

Still further, when practicing an embodiment of the present invention where the owner of the life insurance policy and a third entity receives a payment, payments include payments that are sent to both the owner and the third entity at about the same time (i.e., both the owner and the third entity receive payments at or around the same time). In this invention, the payments also can include payments that are sent to an owner and a third entity but where a payment is first made to the owner and then payment is made to the third entity, or vice versa

The formation of the second agreement is contemplated to provide periodic payments, as noted above, substantially for the life of the insured. That is, as long as the insured lives, these periodic payments would continue to flow.

As noted above, in the first embodiment of the present invention, the annuity according to the second agreement is to be paid to at least one of the first entity and the second entity. However in other embodiments, this annuity payment can be paid to entities other than the first entity and the second entity, as will be discussed in greater detail below.

Still further, as noted above, the transfer of money to the fourth entity in the first embodiment of the present invention constitutes payment by at least one of the first and second entities to the fourth entity. However, in other embodiments of the present invention, the transfer of money to the fourth entity can be paid by other entities other than the first and/or second entity, as will be discussed in greater detail below.

According to the first embodiment of the present invention, the method of investing further comprises the causation of the formation of a third agreement for the transfer of money from a fifth entity in return for repayment of the money at a later date, the repayment of the money also including in some embodiments interest. According to the first embodiment of the present invention, this money is transferred from the fifth entity to the first and/or second entity. In return for this transfer, the fifth entity can receive repayment at a later date comprising principal which is equal to or about equal to the full amount of the money transferred from the fifth entity to the first and/or second entity in the first embodiment of the present invention, as well as interest payments. In the first embodiment of the present invention, the interest payments that the fifth entity receives is an amount that is equal to or about equal to the amount agreed upon according to an interest payment schedule. In the first embodiment of the present invention, the schedule can be agreed upon between the first and/or second entities and the fifth entity, while in other embodiments, the agreement is formed with other entities. In one embodiment, this payment is made to the first and/or second entity, while in other embodiments of the present invention, as will be seen below, the payment comprises the transfer of money from the fifth entity to entities other than the first and/or second entity. In still other embodiments of the present invention, the payment of the principal and/or interest is made to the fifth entity. However, in other embodiments of the present invention, the payment of the principal and/or interest is made to an entity other than the fifth entity or to both the fifth entity and the other entity.

In using the term interest in the present invention, it is meant to include interest on a loan as is typically understood in the banking arts. Interest could include the coupon payment on a bill/note/bond, or other form of payment obligation note. In some embodiments of the present invention, the interest is a fixed rate, while in other embodiments of the present invention, the interest is a variable rate which could be linked to, by way of example only and not by way by limitation, the prime interest rate. Still further by example, this variable rate could be set by agreed upon schedule. In some embodiments of the present invention, this interest payment is made periodically in the form of periodic payments. In other embodiments of the present invention, this interest could conceivable be paid when the note is due or all in advance (near the formation of one of the agreements) or could be partially paid at various time intervals (e.g., when the note is due, at the formation of the agreement, one-half way through the life expectancy of the insured, etc.). Thus, the present invention includes a wide variety of forms of interest payments to the fifth entity (and/or other entities as designated by the third agreement and/or other agreements).

As noted above, according to the first embodiment of the present invention, the principal and/or interest is paid by at least one of the first and second entities. However, in other embodiments of the present invention, as will be seen below, the principal and/or interest can be paid by entities other than the first and/or second entity.

In the first embodiment of the present invention, repayment at a later date of the principal (in an amount about equal to the amount of money transferred from the fifth entity in return for payment at a later date according to a third agreement) occurs shortly after the death of the insured. That is, in the first embodiment, the first and/or second entity receives a death benefit from the life insurance policy of the insured. This death benefit is, by way of example only and not by way of limitation, about equal to the amount of the money transferred from the fifth entity according to the third agreement. That is, according to this embodiment, the first entity and/or second entity could repay the principal that they owe to the fifth entity, and, providing that the interest payments were paid according to the agreement, upon the repayment of the principal to the fifth entity, the first and/or second entity would no longer have an obligation to pay the fifth entity. However, in other embodiments of the present invention, the amount paid to the fifth entity shortly after the death of the insured could be less than or greater than the death benefit.

The method of investing according to the present invention further comprises, as can be inferred from the just mentioned agreement between the fifth entity and the first and/or second entity in regard to the principal, payment of the principal to the fifth entity (or other entity as the case may be) that is “backed” by the benefits of the life insurance policy. That is, according to the first embodiment of the invention, the fifth entity can have a reasonable certainty of receiving repayment of the principal because an agreement can be formed whereby, upon the death of the insured, the death benefit of the insurance policy is guaranteed to result in a payment to the fifth entity, when the death benefit is equal or greater than the principal of the loan from the fifty entity. Still further, as can be seen from the above discussed scenario where the fourth entity pays annuity payments comprising periodic payments for the life of the insured, the interest required to be paid to the fifth entity (or other entity as the case may be) can be guaranteed by the annuity payment to the first and/or second entity according to the second agreement. Thus, an agreement can be formulated whereby the payment of the annuity to the first and/or second entity will result in a guarantee of payment to the fifth entity, wherein this guaranteed payment could comprise an amount equal to or more than the interest payment(s). Thus, by insuring that the periodic payments made by the fourth entity are equal to or greater than the amounts to be paid in interest to the fifth entity, the fifth entity can be guaranteed that it will receive its interest payment as well. It is noted here that while in the first embodiment of the present invention, the annuity payments are made to the first and/or second entity and the death benefit is paid to the first and/or second entity and then, according to the first embodiment of the present invention, the first and/or second entity pays the interest/principal payments to the fifth entity, other embodiments of the present invention can be practiced wherein the payments to the fifth entity come from entities other than the first and/or second entity, as will be seen below.

It is noted that in the first embodiment of the present invention, the third agreement is contingent on the formation of the first agreement and the second agreement. That is, the third agreement can be structured such that the fifth entity will not be obligated to transfer money in return for repayment at a later date, until the first and the second agreements are consummated. However, in other embodiments of the present invention, the agreements are not contingent on one another. It is noted that when it is taught and/or claimed that the third agreement is contingent on the formation of the first agreement and the second agreement, this could include, in some embodiments, a situation where the entities have agreed to agree and the actual consummation of the first agreement and the second agreement are merely formalities. Thus, according to this feature of the present invention, the fifth entity can be substantially assured that there are agreements in place that will almost certainly enable the fifth entity to have a firm guarantee that there is a vehicle in place that will permit the fifth entity to receive both its principal back and its interest. Still further, embodiments of the present invention can be practiced where the first agreement is contingent on the second and/or the third agreement, and the second agreement is contingent on the first agreement and/or the third agreement.

In the first embodiment of the present invention, the premium payments are backed by the annuity payments of the second agreement. That is, the amount of the annuity payments being paid as a result of the second agreement, which in the first embodiment of the invention are paid from the fourth entity to the first/second entity, are in excess to the amount of money that must be paid by the first/second entity as a result of the first/second entity accepting the premium payment obligations of the insured's life insurance policy according to the first agreement. Also, other embodiments of the present invention can be practiced where interest payments are backed by the annuity payments of the second agreement. Still further, according to an embodiment of the present invention, the interest payments resulting from the third agreement, when added to the premium payments resulting from the first agreement are less than the annuity payments that are paid according to the second agreement. As a result, an agreement can be formed whereby the premium payments are backed by the annuity payments because the annuity payments will be greater than the sum of the premium payments and the interest payments (when averaged out on an appropriate temporal scale). It is also noted that the present invention can be practiced where multiple second agreements are made, thus generating multiple annuity payments, the sum of which can be used to back the interest and/or premium payments.

In other embodiments of the present invention, where periodic payments are made to the owner and/or the third entity, these periodic payments can be financed/backed by the annuity payments as well. By way of example only and not by way of limitation, some or all of the money that might otherwise have been paid to the owner as a “lump sum” could instead be paid to the annuity company, thus resulting in higher annuity payments. These higher payments could then be used to pay the periodic payments to the owner and/or third entity.

Still further, in other embodiments of the present invention, some or all of the periodic payments can be paid by the fourth entity to the owner and/or third entity, directly or by way of an intermediate party.

It is noted that while in some embodiments of the present invention the annuity payments are paid to the first and/or second entity and the premium payments are made by the first and/or second entities, other embodiments of the present invention can be practiced where some or all of the annuity payments are paid directly to the entity who would otherwise receive the premium payments from the first or second entity. That is, the present invention could be practiced where the first and second entities do not receive all of or any part of the annuity payment, but instead the annuity payment or a part of the annuity payment is paid to cover the premium payments and/or the interest payments or other expenses or payments associated with the method of investing. Still further, other embodiments of the present invention could be practiced where the first and/or second entity only receive a portion of the annuity payment or receive nothing, but instead a portion of the annuity payments or all of the annuity payments is paid directly to the fifth entity as interest payments (or the entity designated to receive the interest payment). Thus, in some embodiments of the present invention, agreements can be formed where an agreement for the transfer of money to the fourth entity in return for annuity payments comprising periodic payments substantially for the life of the insured that are directed to cover the interest and/or premium payments. That is, embodiments of the present invention can be practiced with agreements that result in periodic payments to entities to cover the expenses and/or obligations associated with the agreements according to the present invention.

In other embodiments of the present invention, the first entity is the same entity as the fifth entity. In such embodiments, the entity from which money is transferred according to the third agreement would be the entity designated to receive the insured's life insurance policy benefits according to the first agreement. That is, by way of example only and not by way of limitation, upon the death of the insured the death benefit would be paid to the fifth entity (as opposed to being paid to one entity and then being transferred to the entity making the loan according to the third agreement). This would effectively remove the middle man and allow the fifth entity even more control over and/or reassurance of the receipt of its principle repayment.

According to one embodiment of the present invention, there is only one payment to one of the owner and/or the third entity according to the first agreement. That is, the owner and/or third entity only receives one payment. In the case where only the owner receives a payment according to the first agreement, the owner only receives one payment. In the case where only the third entity receives one payment according to the first agreement, the third entity only receives one payment.

However, in embodiments of the present invention where the owner of a life insurance policy and the third entity receive a payment according to the first agreement, the owner of the life insurance policy only receives one payment and the third entity only receives one payment.

In yet another embodiment of the present invention, repayment of the principle and/or interest according to the third agreement occurs not at the death of the insured, but at a specified period of time in the event that the insured is still alive at the end of the specified period of time. By way of example only and not by way of limitation, the third agreement can include a clause stipulating that if the insured is still alive after seven years from the date of the formation of any one of the agreements, the fifth entity (or the designated entity to receive the repayment) will receive the repayment, including the principle payment and any outstanding interest owed, at this time or around this time regardless of whether the insured is dead. This will enable the fifth entity (or the successor in interest to the fifth entity) to have legal finality of the terms of the third agreement. That is, the fifth entity will know that by a certain date, they will receive an amount equal to the amount that was transferred from them according to the terms of the third agreement. This provides a safeguard against the possibility that the insured lives for tens of years beyond an estimated date (year) in which the insured should not live past due to his or her life expectancy, as determined through the actuarial sciences, for example.

In yet further embodiments of the present invention, as noted above, the first entity and the second entity are the same entity. That is, by way of example, according to the first agreement, the benefits of the insured's life insurance policy are transferred to the first entity, and the premium payment obligations of the insured's life insurance policy are also transferred to the first entity. However, as noted above, in other embodiments of the present invention, the first entity could be different than the second entity.

It is noted that in the first embodiments of the present invention, most of the agreements result in the transfer of money between the first and/or second entities and the other entities. That is, typically, the agreements of the first embodiment of the present invention are formed between the first and/or second entities and the others. However, other embodiments of the present invention can be practiced that can result in efficiencies from the payments being transferred to other entities, as discussed above. For example, the present invention could be practiced where the money is transferred to the fourth entity according to the second agreement, transferred directly from the fifth entity who is lending the money according to the third agreement. Thus, according to this embodiment of the present invention, the first and/or second entity would not need to receive all of or any of the transferred money from the fifth entity according to the third agreement because the money could be sent directly to the fourth entity. In such a scenario, the fourth entity could still make its periodic payments to the first and/or second entity. In other embodiments of the present invention, some or all of the money transferred from the fifth entity could be transferred to yet another party or entity, such as by way of example and not by way of limitation, an escrow agency, who then transfers the money to the fourth entity.

It is noted that the present invention can be practiced wherein the money transferred to the fourth entity is associated with, in some form or another, the money transferred from the fifth entity according to the third agreement. The phrase “associated with” means that, in some form or another, the money being transferred to the fourth entity is somehow linked to the money transferred from the fifth entity. By way of example and not by way of limitation, a holding company could be set up whereby an agreement is made between the fifth entity and the holding company and the holding company pays the fourth entity money upon receipt of money from the fifth entity. Thus, all that might be necessary to practice some embodiments of the present invention would to be simply to form a system whereby the payment even perhaps the promise to pay or the good faith belief that one entity would be paid results in the payment to another entity. (That is, the money does not necessarily need to be the same money.)

Another efficiency measure that could be taken to practice the present invention is to form an agreement whereby the repayment of the principal to the fifth entity according to the third agreement is repaid by either the issuer of the life insurance policy or its successor in interest (in the event that the life insurance policy has been sold to another insurance company and/or has been acquired resulting through merger, acquisition, etc.) as discussed above. In this embodiment, it might not be necessary for the insurer to pay the first and/or second entity (who would in the first embodiment then turn around and pay off the principal borrowed from the fifth entity). Instead, an arrangement could be made whereby the entity obligated to make a death benefit payment under the terms of the life insurance policy pays the payment directly to the fifth entity. It is noted that while in some embodiments of the present invention the entire death benefit of the insurance policy could be paid directly to the fifth entity, other embodiments of the present invention could be practiced wherein only a portion of the death benefit is paid to the fifth entity. This could be the case where, by way of example only and not by way of limitation, the death benefit paid by the insurer exceeds the principal payment that would be repaid to the fifth entity.

As with the embodiments where payment is being made to the fourth entity directly from the fifth entity, other embodiments of the present invention could be practiced where the payment(s) to the fourth entity according to the second agreement are simply associated in some form or another with the transfer money from the fifth entity according to the third agreement. This could also be the case with money paid by the insurer as a death benefit with respect to the repayment of principal and/or interest to the fifth entity. By way of example only and not by way of limitation, a holding company could be set up where the holding company pays the principal payment to the fifth entity once a payment from the insurer is received. Thus, it is not necessary in some embodiments of the present invention that the money transferred from the insurer be the same as the money transferred to the fifth entity.

Embodiments of the present invention can be practiced wherein the periodic payments that are to be paid to the fifth entity per the terms of the third agreement could be made by the fourth entity directly to the fifth entity. That is, instead of the annuity payments being paid to the first and/or second entity as in the first embodiment of the present invention, all or part of the annuity payments could be paid directly to the fifth entity to pay the interest associated with the money transferred from the fifth entity according to the third agreement. Still further, in other embodiments of the present invention, the money paid to the fifth entity in the form of periodic payments covering, for example, the interest payments, could be simply associated in some form or another with the annuity payments made from the fourth entity. Examples of such embodiments could be similar to the examples just discussed above and are incorporated herein by reference.

Other embodiments of the present invention can be practiced with efficiency measures where all or part of the money paid from the fourth entity in the form of annuity payments can be paid directly to the insurer to cover the costs of the premium payment obligations associated with keeping the life insurance policy in force according to the first embodiment of the present invention. That is, in such embodiments, it would not be necessary for the first entity to receive payments from the fourth entity to cover the premium payment obligations. Again, as with the various embodiments of the present invention, there are embodiments where the premium payments are simply associated with the annuity payments in some form or another, the examples of which can be inferred from the above examples and are incorporated herein by reference.

According to one embodiment of the present invention, the amount of money transferred to the fourth entity according to the second agreement is a percentage of the death benefit that would result from the life insurance policy. That is, it is less than an amount equal to the death benefit from the life insurance policy. In some embodiments of the present invention, this amount is about 35% to about 65% of the death benefit. However other embodiments of the present invention can be practiced where the amount of money transferred to the fourth entity is about 40%, 45%, 50%, 55% and 60% of the death benefit of a life insurance policy, and any range or sub-set range in-between in increments of 0.01%. Other embodiments of the present invention could be practiced at percentages above and below these percentages.

In some embodiments of the present invention, the amount of money transferred to the fourth entity is equal to an amount that will cause the fourth entity to agree to have annuity payments paid, according to the second agreement, in an amount at or about equal to the sum of both the premium payment obligations of a life insurance policy and the interest payments of the third agreement. That is, according to some embodiments of the present method of investing, the money transferred to the fourth entity would result in money being paid to, by way of example only and not by way of limitation, the first and/or second entity in an amount that the first and/or second entity could then turn around and pay to the fifth entity to cover the interest payments on the loan according to the third agreement and/or an amount that would allow the first/second entities to pay the premium payment obligations on the insurance policy. Again, it is noted that it is not necessary for the fourth entity to either pay the annuity payments (as another entity could pay the annuity payments for the fourth entity) and it is not necessary for the annuity payments to be paid to the first and/or second entity because, for example, it could be possible for the annuity payments to be paid to the life insurance company and/or the fifth entity. It is also noted that some embodiments of the present invention could be practiced where a portion of this money is paid directly to the first and second entity, for example, to cover the premium payment obligations and a second portion of this annuity could be paid directly to the fifth entity, while in other embodiments, the part of the money is paid directly to the insurance company to cover the premium payments.

In yet other embodiments of the present invention, the amount of money transferred to the fourth entity could be equal or about equal to an amount that would cause the fourth entity to agree to have annuity payments paid that are about equal to the sum of (1) the premium payment obligations of the life insurance policy, (2) the interest of the third agreement and (3) the administrative fees and costs associated with either or both of the formation of the agreements and the enforcement of the agreements (e.g., administrative expenses, both annual, periodic, reoccurring and one-time expenses). Thus, according to some of the just mentioned embodiments, a method of investing according to the present invention could result in a scenario where, after receiving the money from the fifth entity and paying the fourth entity, the first and/or second entity would be left with a sum that could be paid to the owner and/or the third entity according to the first agreement, as well as to pay other expenses associated with the method of investing (as would be recognized by one of ordinary skill in the art and/or discussed greater herein). This amount left over could be available to be kept by the first and/or second entity or another entity as chosen by the first and/or second entity and could be classified by the general term of profit and specifically as “Profit A.”

However, in other embodiments of the present invention, the method of investing could be practiced wherein the amount of money transferred to the fourth entity is an amount equal to an amount that is equaled to an amount transferred from the fifth entity minus an amount paid by the first and/or second entity to the owner of the life insurance policy and/or the third entity according to the first agreement and/or other payments/costs associated with the formation and/or execution of the agreements according to the present invention. Thus, according to some embodiments of the present invention, this would result in annuity payments paid to, by way of example, the first and/or second entity, that are in excess of the sum of the premium payment obligations of the life insurance policy, the interest being paid according to the third agreement, and administrative fees and costs associated with the formation and enforcement of the agreements and/or other ancillary costs. Thus, instead of leaving a lump sum amount left over after the formation and execution of the agreements to be kept as “Profit A,” the first and/or second entity could instead receive a portion of the annuity payments to be kept as profits (specifically, “Profits B”). Still further, it is noted that in other embodiments of the present invention, this difference could be split, evenly or unevenly. That is, the first and/or second entity could opt to receive a smaller amount of money left over as would be considered “Profit A” as well as having a smaller amount of premium payments left over after paying the expenses associated with practicing the present invention that would be kept as “Profit B.”

In the first embodiment of the present invention, underlying life insurance policies can be purchased directly from the owners of the policies. To this end, insurance agents could assist insureds in disposing of unneeded or unwanted insurance policies. A condition of all first agreements could be, in some embodiments of the present invention, that the insurance policy be “incontestable.” Most states have regulations and/or laws that stipulate that the insurance carrier cannot contest the insurance policy if it is older than two years. Thus, in a first embodiment of the present invention, in the first agreement, the insured's life insurance policy is issued at least two years prior to the formation of the first agreement. This is because some embodiments of the present invention can be practiced with life insurance policies that are incontestable, where incontestable can be defined by state law and can be governed sometimes by NAIC regulations. Such grounds for contesting a policy could be, by way of example and not by way of limitation, a situation where the insured hides the fact that he or she has a life threatening illness. By way of example, if the insured hides the fact that that he or she has terminal cancer and this is not detected by the life insurance policy for two years, the life insurance company cannot contest the life insurance policy and in the event of the death of the insured, must pay the death benefits.

In some embodiments of the present invention, the premium payment obligations on the insured's life insurance policy could potentially fluctuate during the life of the insured. By way of example and not by limitation, some insurance policies have premium payments that decrease over time. By way of example, there is the practice of over funding policies (i.e. funding as large premiums as possibly affordable in the early years of a policy). This can provide various benefits. For example, all growth within an insurance policy can compound on a tax deferred basis. Then, years later, policyholders could benefit from this tax deferred growth in another tax efficient manner, by borrowing against the policy on a tax free basis. These loans may not have to be repaid, as the insurance company may offset them against the death benefit when the insured passes. Another rationale for over funding a policy is that in the later years, the premium may be covered by the growth in cash value, thereby keeping a life policy in force without having to make any premium payments in their senior years.

Alternatively, some insurance policies have premium payments that increase over time. For example, some policy structures are set up for those who want to have large death benefits but wish to initially make as small a premium payment as possible to keep the policy in force, with the expectation of their earning power increasing with age and thereby providing them with the wherewithal to fund large premium payments from employment earnings in later years. Also, for those that do not want to pay large premiums, they can pay smaller premiums to keep the policy in force and assure that they will have insurance in place in the future, when a possible deterioration in their health may make them ineligible for obtaining new insurance.

Flexibility in premium payments can be related to the fact that people tend to statistically live longer each year and thus their life expectancy extends, therefore warranting a reduced premium. Alternatively, factors can be present that would warrant an increase in the premium rates.

Some embodiments of the present invention can be practiced wherein an evaluation of the flexibility of the premium payment obligations of the life insurance policy is performed. Still further, embodiments of the present invention can be practiced where the one or more of the agreements, for example the first, second and/or third, is contingent on the evaluation of the flexibility of the premium payment obligations. In some embodiments of the present invention, if the evaluation shows that the premium payment obligations might result in a substantial increase or even a nonsubstantial increase or perhaps even a potential for a substantial or a nonsubstantial increase in the premium payment obligations, the entity responsible for taking over the premium payments may not be interested in practicing the invention with such a life insurance policy, and thus may not want to enter into some of the agreements.

In some embodiments of the present invention, evaluating the flexibility of the premium payment obligation of the life insurance policy entails evaluating the insurance carriers' illustration of the fixed policy premium amount for the life of the insured. Still further, in other embodiments of the present invention, the illustration is evaluated is in substantial compliance with NIAC regulations.

In some embodiments of the present invention, the method of investing is practiced by further evaluating annual certifications from the insurance carriers' illustration actuary. That is, an illustration actuary, which could be separate from the insurance company and also could be part of the insurance company creates an illustration of the fixed policy premium amount for the life of the insured. From this illustration, the flexibility of the premiums can be estimated. In other embodiments of the present invention, the annual certifications do not necessarily have to be from the insurance carriers' illustration actuary. Indeed, they could be from any illustration actuary.

Recognizing that some insurance policies could have premium payment obligations that will increase during the life of an insured and other policies will have premium payment obligations that could potentially decrease during the life of the insured and still further that other policies could have premium payments that do not increase or decrease during the life of the insured, some methods of the present invention can be practiced by forming a plurality of the first, second and third agreements, thus “spreading-out” the risk of increased premium payment obligations over the net pool of policies obtained by the plurality of the first agreements. To this end, some or all of the first agreements could be contingent on the evaluations of the flexibility of the premium payment obligations of the life insurance policy at issue in the first agreement and the agreement could be entered into upon a determination that the average flexibility of the premiums is acceptable (even if it may go up). That is, by forming a plurality of agreements, the invention could be practiced wherein the average premium for a plurality of agreements is estimated to be substantially constant for a specified period of time (by way of example, about 7 years) after the formation of the first agreements. By way of example only and not by way of limitation, if insurance policies A, B, C, D will probably have premiums that will remain substantially constant for 7 years from the date of the formation of the first agreement and policies E, F and G, will probably have premiums that will decrease by an average amount that is greater than the average expected premium increase of policies H, I, J, K and L, on average, for 7 years, the agreements of the present invention would be formed. Thus, this provides a way to spread out the risk because even though a few policies (indeed, perhaps in some embodiments, the majority of the policies) have premium payment obligations that could increase over, say 7 years, the other policies could have premium payment obligations that decrease over the 7 years, these decreases offsetting the increases of the policies that have increased premium payment obligations. Thus, there would be no relative net loss and/or little net loss due to the premium fluctuations, according to the present invention.

Some embodiments of the present invention can be practiced where an evaluation is made of the risks that the insured life insurance policy will not pay benefits to the designated beneficiary in the event that the company that is obligated to pay the benefits associated with the life insurance policy goes bankrupt or otherwise seeks protections under the various laws protecting debtors from their creditors. To this end, some embodiments of the present invention can be practiced by only entering into first agreements where the company responsible for the insured's life insurance policy is governed by the bankruptcy laws that permit the beneficiaries of the policy to take ahead of most other creditors. Still further, other embodiments of the present invention can be practiced wherein the company is controlled by bankruptcy laws that permit the beneficiaries of the policy to take ahead of substantially all other creditors or all other creditors. Thus, the first and/or second entities (or other entities entitled to receive the benefits from the life insurance policy) and/or the fifth entity could be assured that they would receive some or all of the benefits of the life insurance policy in the event that the company obligated to pay the death benefits goes bankrupt.

As noted above, embodiments of the present invention can be practiced where it is desirable for some or all of the entities associated with the various agreements according to the various embodiments of the present invention to obtain legal finality at a date certain, or at least have the option to obtain legal finality at the date certain. To this end, some embodiments of the present invention comprise forming a fourth agreement for the transfer of the premium payment obligations from either the first entity or the second entity, and the payment of an amount equal to the full amount of the money transferred from the fifty entity after an agreed upon time, in the event that the insured has not died, in return for a payment to a sixth entity after the consummation of the fourth agreement.

By way of example only and not by way of limitation, the just described embodiment of the present invention could be practiced as follows: The fifth entity could desire to have his or her principal and interest paid in full within, for example, 7 years. Thus, according to this embodiment, at the end of 7 years, there will be two possibilities. The first is that the insured has died, in which case the fifth entity could receive their principal from the death benefit paid by the life insurance policy (the interest could have been paid from the annuity payments during the life of the insured). The second possibility is that the insured is still alive and, thus, no death benefits have been paid. According to this embodiment of the present invention, in such a scenario, the fourth agreement could result in the payment of an amount equal to or about equal to the death benefit of the life insurance policy and/or the amount of money transferred from the fifth entity according to the third agreement (although in other embodiments of the present invention, the amount could be greater than or less than these amounts). Thus, according to this embodiment of the invention, a sixth entity could be paid as part of the fourth agreement, and this sixth entity would pay the just discussed amount. The sixth entity could then assume the rights to benefits under the insurance policy and/or would also be obligated to maintain the premium payments of the policy. Although in other embodiments, this sixth entity could in fact allow the life insurance policy to lapse, depending on various agreements that could be worked out between the remaining entities associated with the present invention. Thus, the fifth entity could drop out of the picture, having received its principal repayment. In some embodiments of the present invention, such a scenario could be generally described as “putting” the life insurance policy to, by way of example and not by way of limitation, a life contingency insure and/or performance bond issuer or other form of guarantor. While in some embodiments of the present invention, the sixth entity could be permitted to allow the policy to lapse. Other embodiments of the present invention would require this sixth entity to or some other entity to continue to pay the premium payments on the life insurance policy.

In a scenario where the life insurance policy is “putted” and the insured person still continues to live after the policy is “putted,” the life annuity payments could be kept in full by the first and/or second entities. In embodiments of the present invention where the annuity payments are paid to other parties to cover the expenses associated with, for example, the interest on the money transferred from the fifth entity and/or the premium payment obligations, this money could then be redirected to the first or second entity or to another entity. Still further, in other embodiments of the present invention, the payments could continue be directed to the entity receiving payments prior to the put.

The time period where the life insurance policy will be specified to be “putted” can be based on the life expectancy of the insured. By way of example and not by way of limitation, if the insured is expected to live about 5 years after the formation of one of the agreements, the fourth agreement can specify that the policy can be putted, say, in 7 years. Alternatively by example, a 3 year period could be used, thus the policy would be putted after 8 years. This will provide legal finality to some or all of the entities.

In some embodiments of the invention, the first entity and/or the second entity could have the option to block the transfer of the premium payment obligations according to the fourth agreement after the formation of the fourth agreement.

It can be seen that an early death of the insured person results in an early payment to the entity or entities receiving the benefits of the life insurance policy under the agreement (or their assigns). The corollary to this is that an early death of the insured person will usually result in the termination of the requirement to pay life insurance premium payments to the issuer of the insurance policy (or their assigns). Thus, in this regard, an early death of the insured person both reduces the number of payments that the first/second entities must make, both to the insurance company and to the owner of the policy, and can thus result in an immediate cash windfall. To this end, embodiments of the present invention could be practiced by forming agreements with owners of life insurance policies where the insured has some form of life impairment. By way of example and not by way of limitation, if the insured person has recently been diagnosed with diabetes or Alzheimer's, for example, there is a higher likelihood that this person will die sooner than a similarly situated person who has a medical status the same as or substantially the same as the average person at that person's age. That is, the present invention could be most profitable to the first entities when practiced with insured people who are “worse off,” medically speaking, than a similarly situated person in their age group.

As noted above, the various entities that are parties to the agreements and/or underwriting the parties to the agreements might find it to their advantage that the insured person expires sooner rather than later. To this end, the present invention could be practiced by evaluating the life expectancy of the insured person prior to forming the agreement. This could be done in a variety of ways, one of which is to identify the insured person's life expectancy based on his rated age. This is illustrated by the following example (which is not by way of limitation): In 1991, Mr. Smith, then 64 years of age, bought a universal life insurance policy with a death benefit of $1 mil. from life Insurance company. It is now almost 13 years later and Mr. Smith, presently 77 years of age, has suffered a degradation in his health. In fact although his chronological age is 77 years, he has a “rated age” of 81 years. The rated age reflects the health conditions he now suffers from which may cause the insurance community to look at him and price products for him as though he were 4 years older.

In determining the life expectancy of the insured, one method that can be used is to use a method that is generally the same as the method that was used to underwrite the insured's life insurance policy. That is, when the insured purchased the life insurance policy, the issuing insurance company probably utilized a life actuarial estimation method to estimate how long the insured would live, and thus determine, by way of example, what the premium payments should be so as to return a profit. According to the present invention, a generally similar method would be used to estimate the insured's current life expectancy. This could take into account the insured's current medical condition. By way of example, an insured person who has contracted Alzheimer's or who has been diagnosed with Alzheimer's should, statistically speaking, have a shorter life expectancy than a similarly situated person who has not contracted the disease. In still other embodiments of the present invention, the life expectancy of the insured is determined using at least one method that is generally the same as one or more of the commonly accepted methods used to currently underwrite life insurance policies. That is, successful insurance companies usually have standard procedures that they follow to estimate the life expectancy of a person. While these methods can vary from one insurance company to another, the methods are still generally the same, and thus the end result should not differ between the systems by a significant amount. Still further, many insurance companies utilize multiple systems whereby the estimated life expectancies are averaged and/or normed in some manner, or the shortest life expectancy is relied on to error on the side of caution (e.g., a life insurance policy would probably identify the shortest life expectancy because that would be the one that would result in the highest financial burden to the insurance company). Thus, the present invention could utilize common methods or similar methods to establish such policies. Still further, embodiments of the present invention could utilize such methods and also take into account the insured's medical condition, wherein the insured has an impaired life (e.g., Alzheimer's). However, in other embodiments of the present invention, a novel or uncommon life estimation method could be used.

Some methods that can be utilized with the present invention to estimate the life expectancy of an insured comprise determining the insured's current age which could, but does not necessarily require, obtaining a certified copy of the insured's birth certificate, determining the sex of the insured (because, for example, it is known that males in the United States, statistically speaking, have shorter life expectancies than females, although in other situations, it is possible that males could have a longer life expectancy depending on whether or not there are other ailments or lifestyle factors that could influence the life expectancy estimation), determining the present medical condition of the insured, and identifying the presence or absence of medical conditions among at least one member or more than one member of the insured's family (e.g., identifying whether the insured's mother and/or father had a heart attack, skin cancer, heart disease, etc.). Further, a method used to determine the life expectancy of an insured could also include identifying the presence or absence of lifestyle choices previously made by the insured that are statistically linked to a shortened life expectancy. By way of example only and not by way of limitation, an insured who smokes two packs of cigarettes a day, statistically speaking, should have a shorter life expectancy than a similarly situated person who does not smoke. Still further by way of example, an insured person who drinks alcohol in an abusive and problematic manner should, statistically speaking, have a shorter life expectancy than a similarly situated person who abstains from alcohol consumption. Thus, the present invention includes a method or methods to estimate the life expectancy of the insured, and the present invention can be practiced using any method that can accurately or otherwise reasonably estimate the life expectancy of the insured, wherein reasonable accuracy would still allow the first/second entities to receive an acceptable profit per agreement (wherein profits include, but one not limited to, the compounding effect resulting from monies saved by the death of the insured).

The present invention also comprises a computer system that can be used to practice the present invention in whole or in part.

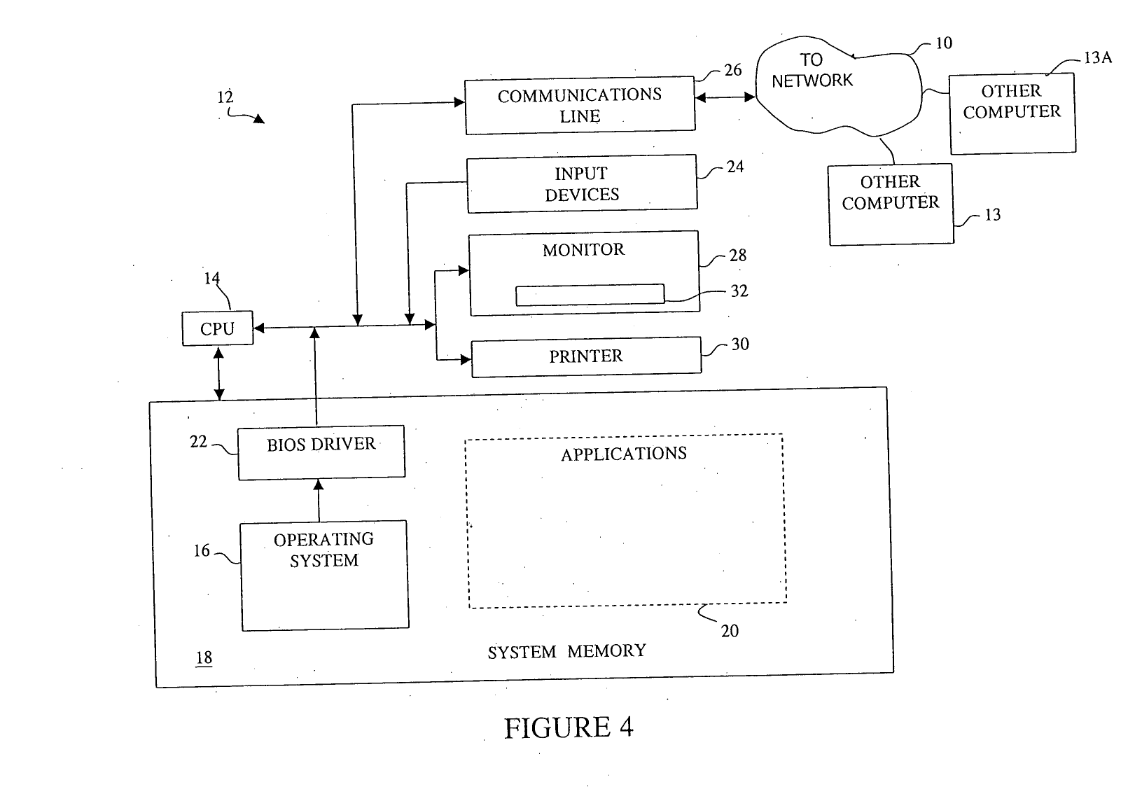

FIG. 4 shows a diagram showing the components of a general purpose electronic network 10, such as a computer network. The computer network can be a public network, such as the Internet. As shown in FIG. 1, the computer system 12 including a central processing unit (CPU) 14 connected to a system memory 18. The system memory 18 typically contains an operating system 16, a BIOS driver 22, and application programs 20. In addition, the computer system 12 contains input devices 24 such as a mouse or a keyboard 32, and output devices such as a printer 30 and a display monitor 28, The computer system generally includes a communications interface 26, such as an ethernet card, to communicate to the electronic network 10. Other computer systems 13 and 13A also connect to the electronic network 10 which can be implemented as a Wide Area Network (WAN) or as an internetwork such as the Internet.

One skilled in the art would recognize that the above describes a typical computer system connected to an electronic network. It should be appreciated that many other similar configurations are within the abilities of one skilled in the art and it is contemplated that all of these configurations could be used with the method of the present invention. Furthermore, it should be appreciated that it is within the abilities of one skilled in the art to program and configure a computer system to implement the method steps of the present invention, discussed herein.

Furthermore, the present invention contemplates providing computer readable data storage means with program code recorded thereon for implementing the method steps described herein.

In one embodiment of the present invention that utilizes a computer system, there is logic to determine the approximate and/or exact amount of at least one of the amount that should be paid to the owner of the life insurance policy/third entity according to the first agreement, the amount that can be transferred to the fourth entity, the amount of annuity payments that should be received for the life of the insured, the amount of money to be transferred from the fifth entity, the amount of the repayment of principal to the fifth entity, and the amount of interest to be repaid to the fifth entity, so that at least one of the entities can turn a profit by practicing the invention, or for other reasons. Thus, a benefit to practicing this embodiment is that the return on investment for the investor could be more easily determined because the costs and benefits of practicing the invention can be managed in a data base and thus manipulated to estimate returns on investment. The computer system could be adapted to vary the amounts of some payments or variables associated with the payments (such as, by way of example and not by way of limitation, the life expectancy of the insured, interest rates, etc.) to estimate how the other variables could be manipulated or adjusted to return a profit.

In other embodiments of the present invention, there is a computer system to track some or all of (as well as actions associated with or what entities are doing what) the payments, transfers, the expiration of the insured, and/or other actions according to the agreements of the present invention, and to track whether the terms of the agreement are being fulfilled, etc. To this end, there is a computer system according to the present invention to manage one or more or all of the various embodiments of the present invention. Such a system could be configured to receive inputs from a user, such as a query as to whether an action has been performed, and output the status or lack of status of the action. Still other embodiments could be configured to output reminders, form schedules based on actions associated with the agreements of the invention, etc., to assist in the practice of the invention and/or to manage the practice of invention.

Still further, the computer system could be used to estimate the appropriate amount of the various payments that will provide for a given return on investment with the assumption that the insured will live a certain number of years and/or for a fixed period of time as described above. The logic used to determine the general amount of the payments can be based on the life expectancy of the insured. That is, logic can be used to estimate how much money should be paid out in order to obtain a profitable and acceptable return of investment, assuming that the insured will only live to his or her expected life expectancy. Still further, in other embodiments of the present invention, logic includes an algorithm to estimate decreases in profit and/or losses the event that the insured lives beyond his or her life expectancy. In further embodiments of the present invention, this life expectancy could be based on a rated age of the insured, as described above in further detail. Thus, this would permit the computer system of the present invention to estimate the periodic payments to be made by simply inputting the rated age of an insured and comparing the difference to that rated age and a generic number based on the sex of the insured, or alternatively not based on anything (for example, in the event that the rated age takes into account the sex of the insured), so that, by way of example, the computer system can estimate the payments without requiring a computer system that must rely on and/or be compatible with life actuarial sciences (e.g., the computer system can be a “dumb” system, because the life estimating portions of the method would be practiced for example, by a separate subcontractor).

Still other embodiments of the present invention can be practiced by inputting at least some pertinent information relating to the agreements (whether consummated, planned to be consummated, or considered as an option) according to the present invention into a computer terminal. By way of example and not by limitation, a computer terminal could simply include or be limited to a “dumb” monitor linked to a mainframe that could be or is not located in the same building or same region with the computer terminal, and could also include a personal computer. This information could then be transferred to a computer. By way of example and not by way of limitation, this computer could be a mainframe computer located in the same building or in another building or in another region. In other embodiments of the present invention, the computer terminal could be located in one region separate from the region in which the computer to which the information is transferred is located. Indeed, in some embodiments of the present invention, the computer terminal could be located in one country and the computer to which the information is transferred could be located in another country. Thus, some embodiments of the present invention could include simply putting pertinent information about the agreement of the invention into a keyboard.

Embodiments within the scope of the present invention include program products on computer-readable media and carriers for carrying or having computer-executable instructions or data structures stored thereon. Such computer-readable media can be any available media which can be accessed by a general purpose or special purpose computer. By way of example, such computer-readable media can comprise RAM, ROM, EPROM, EEPROM, CD-ROM or other optical disk storage, magnetic disk storage or other magnetic storage devices, or any other medium which can be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such a connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

The invention is described in the general context of method steps which may be implemented in one embodiment by a program product including computer-executable instructions, such as program modules, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represent examples of corresponding acts for implementing the functions described in such steps.

The present invention is suitable for being operated in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices

It should be noted that although the flow charts provided herein show a specific order of method steps, it is understood that the order of these steps may differ from what is depicted. Also, two or more steps may be performed concurrently or with partial concurrence. Such variation will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

1. A computer implemented method for investing, comprising:
causing the formation of a first agreement for the transfer of benefits of an insured's life insurance policy to a first entity and the transfer of premium payment obligations of the insured's life insurance policy to the first entity or a second entity in exchange for a payment to at least one of an owner of the life insurance policy and a third entity;
causing the formation of a second agreement for the transfer of money to a fourth entity in return for annuity payments comprising periodic payments substantially for the life of the insured; and
causing the formation of a third agreement for the transfer of money from a fifth entity in return for repayment at a later date, the repayment at a later date comprising principal substantially equal to the full amount of the money transferred from the fifth entity plus interest, wherein payment of the principal is backed by benefits of the insured's life insurance policy and wherein the interest is backed by the annuity payments of the second agreement.

2. The method of claim 1, wherein the wherein the third agreement is contingent on the formation of the first agreement and the second agreement.

3. The method of claim 1, the payment to at least one of an owner of the life insurance policy and a third entity occurs in close temporal proximity with the consummation of the first agreement.

4. The method of claim 1, wherein an entity other than the fifth entity receives the payment of the interest.

5. The method of claim 1, wherein
the annuity of the second agreement is paid to at least one of the first entity and the second entity; wherein
the transfer of money from the fifth entity is transferred to at least one of the first entity and the second entity; wherein
the repayment at a later date of the third agreement comprises the receipt of periodic payments by the fifth entity of an amount substantially equal to the agreed upon interest of an interest payment schedule; wherein
the repayment at a later date of the third agreement further comprises the receipt shortly after the death of the insured of an amount substantially equal to the full amount of the money transferred from the fifth entity; wherein
the payment to at least one of an owner of the life insurance policy and a third entity is made by at least one of the first and second entities; wherein
the transfer of money to the fourth entity is paid by at least one of the first and second entities; wherein
the repayment of the third agreement is paid by at least one of the first and second entities; and wherein
the premium payments are backed by the annuity payments of the second agreement.

6. The method of claim 1, wherein the interest payments stop at the death of the insured.

7. The method of claim 1, wherein the first entity is the same as the fifth entity.

8. The method of claim 1, wherein the premium payments are backed by the annuity payments of the second agreement.

9. The method of claim 1, wherein there is only one payment to at least one of an owner of the life insurance policy and a third entity.

10. The method of claim 5, wherein the only one payment is paid to both the owner of the policy and a third entity.

11. The method of claim 1, wherein the repayment of the third agreement comprises the receipt of periodic payments by the fifth entity of an amount substantially equal to the agreed upon interest of an interest payment schedule.

12. The method of claim 1, wherein the repayment of the third agreement comprises the receipt shortly after the death of the insured of an amount substantially equal to the full amount of the money transferred from the fifth entity.

13. The method of claim 1, wherein the repayment of the third agreement occurs at either a time shortly after the death of the insured or a time specified in the third agreement in the event that the insured is not dead prior to the specified time, the repayment comprising the receipt of an amount substantially equal to the full amount of the money transferred from the fifth entity.

14. The method of claim 1, wherein the repayment of the third agreement occurs at either a time shortly after the death of the insured or a time specified in the third agreement in the event that the insured is not dead prior to the specified time, the repayment comprising the receipt of an amount substantially equal to the combined amount of interest owed to the fifth entity.

15. The method of claim 1, wherein the interest payment is made in close temporal proximity to the consummation of the first agreement.

16. The method of claim 1, wherein no interest is paid until either a time shortly after the death of the insured or a time specified in the third agreement in the event that the insured is not dead prior to the specified time.

17. The method of claim 1, wherein the annuity of the second agreement is paid to at least one of the first entity and the second entity.

18. The method of claim 1, wherein the first entity and the second entity are the same.

19. The method of claim 1, wherein the transfer of money to the fourth entity is transferred from the fifth entity.

20. The method of claim 1, wherein the transfer of money to the fourth entity is associated with money transferred from the fifth entity.

21. The method of claim 1, wherein the repayment of the principal is paid to the fifth entity by at least one of the issuer and the successor to the issuer of the life insurance policy.

22. The method of claim 1, wherein the repayment of the principal is paid to the fifth entity by the issuer of the life insurance policy.

23. The method of claim 1, wherein the repayment of the principal paid to the fifth entity is associated with the benefits of the insured's life insurance policy.

24. The method of claim 6, wherein the periodic payments paid to the fifth entity by the fourth entity and comprise at least a portion of the annuity payments.

25. The method of claim 6, wherein the periodic payments paid to the fifth entity are associated with the annuity payments from the fourth entity.

26. The method of claim 1, wherein the premium payment obligations of the life insurance policy are paid by the fourth entity and comprise at least a portion of the annuity payments.

27. The method of claim 1, wherein the premium payment obligations of the life insurance policy are associated with the annuity payments.

28. The method of claim 1, wherein the amount of money transferred from the fifth entity in return for repayment at a later date is about equal to the amount of a death benefit from the life insurance policy.

29. The method of claim 1, wherein the amount of money transferred to the fourth entity is equal to an amount that will cause the fourth entity to agree to have annuity payments paid for the life of the insured in an amounts that are about equal to the sum of the premium payment obligations of the life insurance policy and the interest of the third agreement.

30. The method of claim 22, wherein the fourth entity pays the annuity.

31. The method of claim 1, wherein the amount of money transferred to the fourth entity is about equal to an amount that will cause the fourth entity to agree to have annuity payments paid for the life of the insured in an amounts that are about equal to the sum of the premium payment obligations of the life insurance policy, the interest of the third agreement, and administrative fees and costs associated with the formation of the agreements and the enforcement of the agreements.

32. The method of claim 1, wherein the amount of money transferred to the fourth entity is about equal to the amount transferred from the fifth entity minus the amount paid to at least one of the owner of the life insurance policy and the third entity.

33. The method of claim 1, wherein the amount of money transferred to the fourth entity is about equal to the amount transferred from the fifth entity minus (A) the amount paid to at least one of the owner of the life insurance policy and the third entity and (B) administrative expenses.

34. The method of claim 1, wherein the amount of money transferred to the fourth entity is about equal to an amount that will cause the fourth entity to agree to have annuity payments paid for the life of the insured in an amounts that are greater than the sum of the premium payment obligations of the life insurance policy, the interest of the third agreement, and administrative fees and costs associated with the formation of the agreements and the enforcement of the agreements.

35. The method of claim 34, wherein the amount of money transferred to the fourth entity is about equal to an amount that will cause the fourth entity to agree to have annuity payments paid for the life of the insured in an amounts that are greater than the sum of the premium payment obligations of the life insurance policy, the interest of the third agreement, and administrative fees and costs associated with the formation of the agreements and the enforcement of the agreements, and wherein the amount of money transferred to the fourth entity is about equal to the amount transferred from the fifth entity minus the amount paid to at least one of the owner of the life insurance policy and the third entity.

36. The method of claim 34, wherein the amount of money transferred to the fourth entity is about equal to an amount that will cause the fourth entity to agree to have annuity payments paid for the life of the insured in an amounts that are greater than the sum of the premium payment obligations of the life insurance policy, the interest of the third agreement, and administrative fees and costs associated with the formation of the agreements and the enforcement of the agreements, and wherein the amount of money transferred to the fourth entity is less than the amount transferred from the fifth entity minus the amount paid to at least one of the owner of the life insurance policy and the third entity.

37. The method of claim 24, wherein the annuity payments paid that are substantially in excess of the sum of the premium payment obligations of the life insurance policy, the interest of the third agreement, and administrative fees and costs associated with the formation of the agreements and the enforcement of the agreements.

38. The method of claim 1, wherein the life insurance policy was issued at least two years prior to the formation of the first agreement.

39. The method of claim 1, wherein the life insurance policy is incontestable.

40. The method of claim 1, wherein the life insurance policy is incontestable as based on the NAIC regulations.

41. The method of claim 1, further comprising evaluating the flexibility of the premium payment obligations of the life insurance policy, wherein the first agreement is contingent on the evaluation.

42. The method of claim 29, wherein evaluating the flexibility of the premium payment obligations of the life insurance policy entails evaluating the insurance carrier's illustration of the fixed policy premium amount for the life of the insured.

43. The method of claim 30, wherein the illustration is in substantial compliance with NAIC regulations.

44. The method of claim 29, further comprising evaluating the annual certifications from the insurance carrier's illustration actuary.

45. The method of claim 29, further comprising evaluating the annual certifications from an illustration actuary.

46. The method of claim 1, further comprising forming a plurality of first, second and third agreements, evaluating the flexibility of the premium payment obligations of the life insurance policies of the agreements, wherein the first agreements are contingent on the evaluations, and wherein the average premium for the plurality of agreements is substantially constant for about seven years after the formation of the first agreements.

47. The method of claim 1, wherein the life insurance policy is controlled by the bankruptcy laws that permit the beneficiaries of the policy to take ahead of most other creditors.

48. The method of claim 1, wherein the life insurance policy is controlled by the bankruptcy laws that permit the beneficiaries of the policy to take ahead of substantially all other creditors.

49. The method of claim 1, further comprising forming a fourth agreement for the transfer of the premium payment obligations and the payment of an amount equal to the full amount of money transferred from the fifth entity after an agreed upon time in the event that the insured has not died from either the first entity or the second entity in return for a payment to a sixth entity.

50. The method of claim 1, further comprising forming a fourth agreement for the transfer of the premium payment obligations and the payment of an amount equal to the full amount of money transferred from the fifth entity after an agreed upon time in the event that the insured has not died from either the first entity or the second entity in return for a payment in close temporal proximity with the consummation of the fourth agreement to a sixth entity.

51. The method of claim 37, wherein the sixth entity is a life contingency insurer or a performance bond issuer or other guarantor.

52. The method of claim 37, wherein the transfer of the premium payment obligations from either the first entity or the second entity can be blocked by the first entity or the second entity after the formation of the fourth agreement.

53. The method of claim 37, wherein the agreed upon time in the event that the insured has not died is about two years after the expected approximate death date of the insured.

54. The method of claim 1, further comprising using a personal computer to practice the method.
